(19) United States
(12) Patent Application Publication
(10) Pub. No.: US 2002/0183666 A1
(43) Pub. Date: Dec. 5, 2002

(54) Back-mountable massage device

(76) Inventor: Jeong-Joo Suh, Seoul (KR)

Correspondence Address: CHRISTIE, PARKER & HALE, LLP, 350 WEST COLORADO BOULEVARD, SUITE 500, PASADENA, CA, 91105, US

(21) Appl. No.: 09/994,991

(22) Filed: Nov. 20, 2001

(30) Foreign Application Priority Data
May 31, 2001 (KR) 2001-30349

(51) Int. Cl. A61H 7/00

(52) U.S. Cl. 601/84

(57) ABSTRACT

A massage device includes a supporting cover designed to be put on a human body, a massage part for massaging the back while moving along a part of the human body, on which the supporting cover being put, the massage means being provided in the supporting cover, and a driving part for driving and controlling the massage means.

### BACKGROUND OF THE INVENTION

1. Field of the Invention

The present invention relates to a massage device, and more particularly, to a massage device that can knead the human body such as the neck and shoulders in a state where it is mounted on the back, thereby obtaining a finger-pressure therapy effect while saving a massaging space.

2. Description of the Related Art

Generally, a massage device is used to obtain selected stroking, rubbing and/or kneading massaging effects of the human body to increase the blood flow and obtain muscle relaxation.

A body massage may be divided into three levels of rising intensities. The first level, known in the art as stroking, involves a smoothing action characterized by mild to medium pressure applied onto a body part being massaged. Stroking is meant to warm-up and thereby prepare the body part being massaged to the following massage levels. The second level, known in the art as rubbing, involves a pressing and rubbing action characterized by movement of the tissue and medium to high pressure applied on the body part being massage. Rubbing is meant to increase the blood flow in the body part being massaged. The third level, known in the art as kneading, involves a pressing and kneading actions characterized by high pressure applied onto the body part being massaged. Kneading is typically a deep and through muscle massage extends over a relatively prolonged time minutes or more.

Such massage devices may be categorized into a vibration-type massage device and a kneading/rubbing-type massage device. The vibration-type massage is designed to convert a rotation movement of a motor into a vibration movement of a massage head. The kneading/rubbing-type massage device is designed to convert a rotation movement into a rubbing/kneading movement of a massage element.

Generally, such a vibration-type massage device is a hand-held type so that the user can held and locate the device on a body part to be massaged. However, the vibration-type massage cannot sufficiently provide the massage effect as it repeats its vibration.

In addition, such a rubbing/kneading-type massage device should be associated with a body supporting apparatus such as a chair or bed such that the user can use it in a state where the user's body is located and stuck onto the body supporting apparatus. Therefore, the conventional rubbing/kneading-type massage device has a problem that the body part to be massage is limited to a specific part such as the waist and the back that can be located on the body supporting apparatus.

### SUMMARY OF THE INVENTION

Therefore, the present invention has been made in an effort to solve the above-described problems.

It is an objective of the present invention to provide a rubbing/kneading-type back-mountable massage device that can be used without being associated a body supporting apparatus such as a chair and a bed, thereby saving a space it occupies.

To achieve the above objectives, the present invention provides a massage device comprising a supporting cover designed to be put on a human body; massage means for massaging the back while moving along a part of the human body, on which the supporting cover being put, the massage means being provided in the supporting cover; and a driving part for driving and controlling the massage means.

The massage device may further comprise a power transmission part disposed between the massage means and the driving part to convert a rotational motion of the driving part into a linear reciprocal motion.

Preferably, the power transmission part comprises a driving shaft supported by a pair of supporting blocks facing each other, a roll fixed on the driving shaft to rotate with the driving shaft, and wires connected to a proximal end of the roll and extended out of the driving part.

A sensor is provided in the power transmission part to detect a roll RPM, a detected signal being transmitted to the motor.

Preferably, the supporting cover may further comprise a supporting part designed having a similar curvature to that of a specific body part on which they are to be put on.

Preferably, the massage means comprises a pair of supporting members vertically mounted on an inner wall of the main body, a lower plate coupled by a hinge member on the inner wall of the main body under the supporting members, a rear plate fixed on the rear portion of the supporting members to be disposed on the rear wall of the main body, an air bag disposed between the main body and the rear plate, a guide member supported on the lower plate, a roller mounted on the guide member, and a back massage part for massage the back while ascending and descending along the guide member

Preferably, the back massage part comprises a slider in the guide member coupled to one of the wires, the slider ascending and descending as the wire coupled released and wound, plural press parts disposed on both sides of the slider and performing the massage operation according to a solenoid, a guide roller allowing the solenoid to move along the curvature as the slider ascends and descends. The back massage part may further comprise a vibrator for vibration the press parts by vibrating the slider.

Further preferably, the back massage part may further comprise a thermo-heater for generating heat by electric power.

The massage device may further comprise an air back for biasing the back massage part to the human body, the air back being disposed between the main body and the supporting members.

The massage means is controlled in its operation time and operation mode by a control part.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a perspective view of a massage device according to a preferred embodiment of the present invention;

FIG. 2 is an enlarged sectional view illustrating assembled massage means according to a preferred embodiment the present invention;

FIG. 3 is a partly enlarged perspective view of a driving part and a power transmission part of a massage device according to a preferred embodiment of the present invention;

FIG. 4 is an enlarged perspective of massage means according to a preferred embodiment of the present invention;

FIG. 5 is a front view of FIG. 4; and

FIG. 6 is a sectional view of massage means mounted on the back according to a preferred embodiment of the present invention

### DETAILED DESCRIPTION OF THE PREFERRED EMBODIMENTS

A preferred embodiment of the present invention will be described in detail with reference to the accompanying drawings.

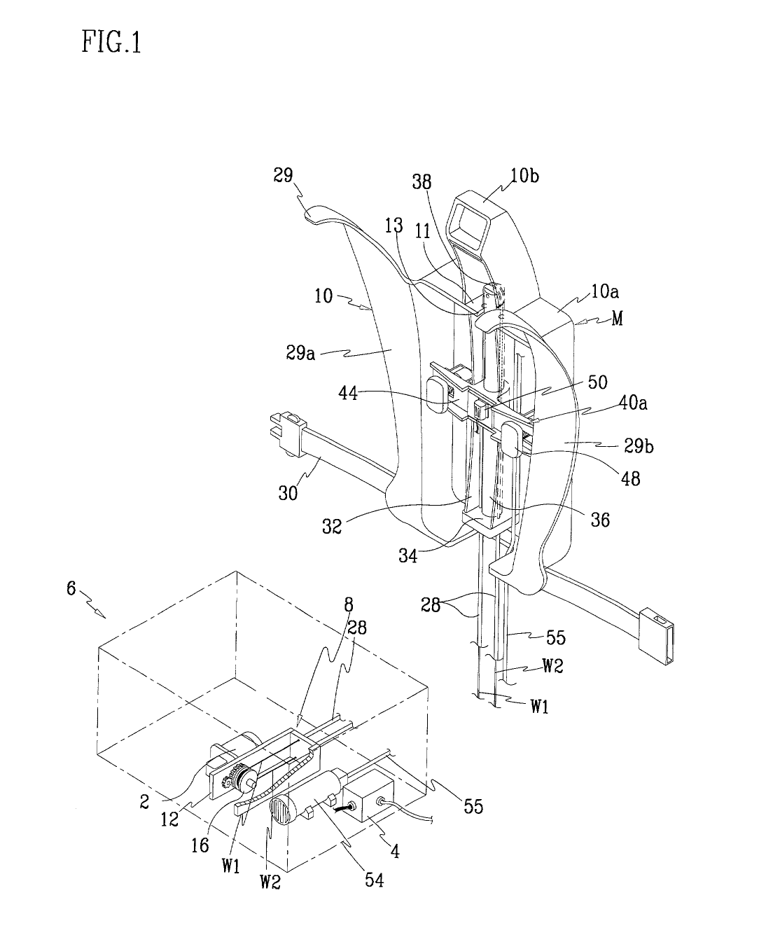

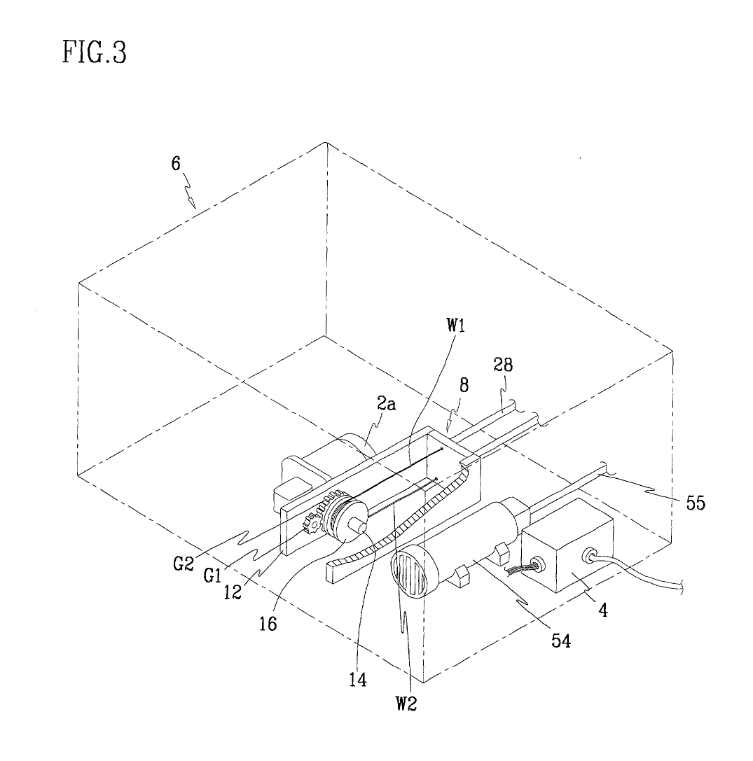

FIGS. 1, 2 and 3 show a massage device according to a preferred embodiment of the present invention.

Referring first to FIG. 1, the inventive massage device comprises a driving part 6 having a driving source such as a motor 2 and a controller 4 for controlling the operation of the motor 2; a power transmission part 8 for converting a rotational motion of the motor 2 into a linear reciprocal motion; a supporting cover 10 designed to be suitable to a human body so that it can put on the back of a user to be massaged; and a variety of massage means M for massaging the shoulder, back or neck, the massage means being mounted on the supporting cover 10 and connected to the power transmission part 8.

The controller 4 controls a massage time and a variety of massage modes such as a stroking, rubbing and kneading modes.

The power transmission part 8 transmits driving force created by the motor 2 to each massage means. The power transmission part 8 comprises a driving shaft 14 supported by a pair of supporting blocks 12 facing each other, a roll 16 fixed on the driving shaft 14 to rotate with the driving shaft 14, and wires W1 and W2 connected to a proximal end of the roll 24 and extended out of the driving part 6.

The driving shaft 14 receives the driving force from a driven gear G2 engaged with a driving gear G1 rotated by the motor 2.

Mounted on one end of the roll 16 is a sensor (not shown) for detecting the RPM of the roll 16. A signal detected by the sensor is transmitted to the motor 2 via the controller 4 and controls the rotational direction and RPM of the roll 16.

Preferably, portions of the wires W1 and W2, which are disposed out of the power transmission part 8, are covered with protecting covers 28.

The above-described massage device is operated in a variety of modes according to the adjustment of a massage mode switch (not shown).

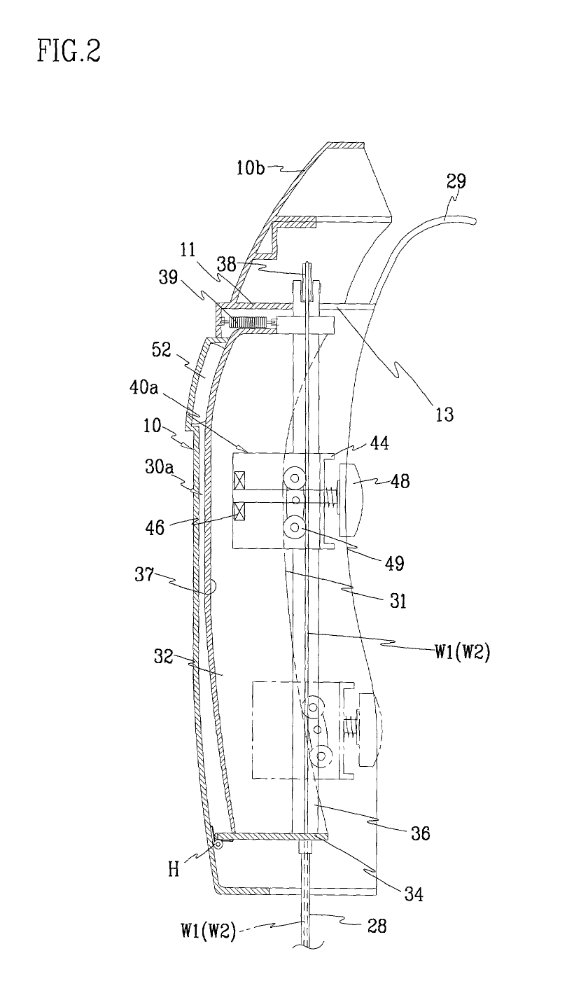

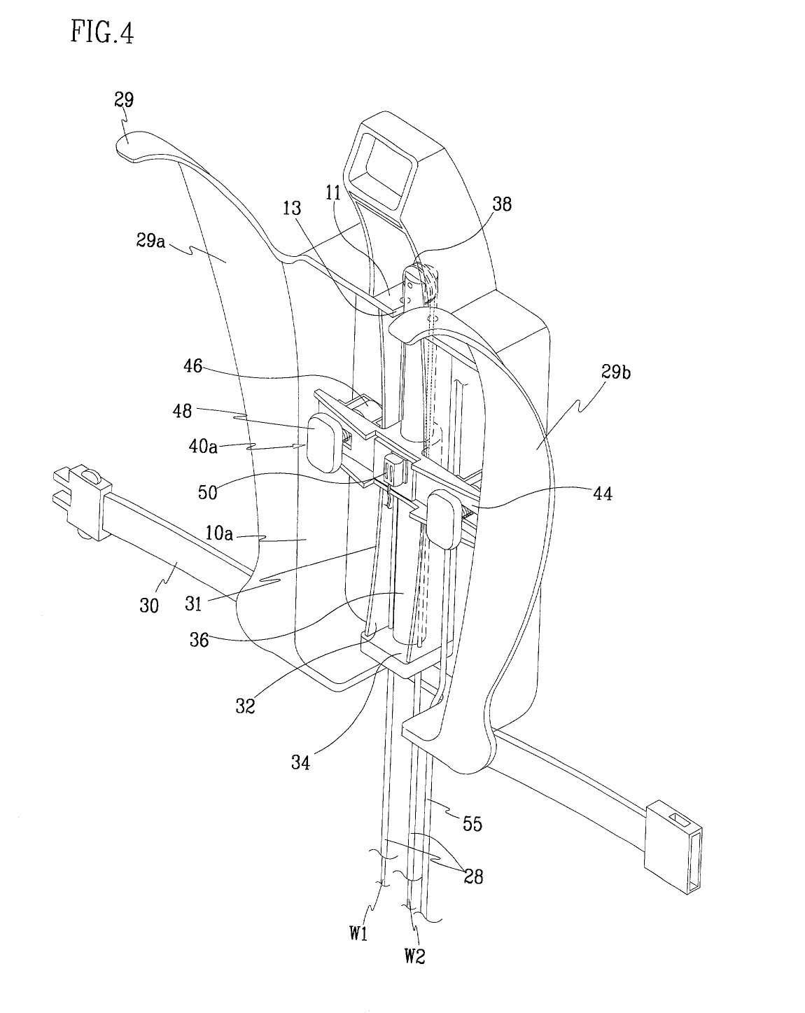

In addition, as shown in FIGS. 2 and 4, the supporting cover 10, in which the variety of massage means operated by the power transmission part 8 is mounted, comprises a main body 10a having left and right supporting members 29a and 29b designed having a similar curvature to that of a specific human body part on which they are to be put on.

Provided on both lower sides of the main body 10a is a waist belt 30 by which the main body 10a of the supporting cover 10 can be closely supported on the human body.

Preferably, a shoulder belt (not shown) may be further provided on the left and right supporting parts 29a and 29b.

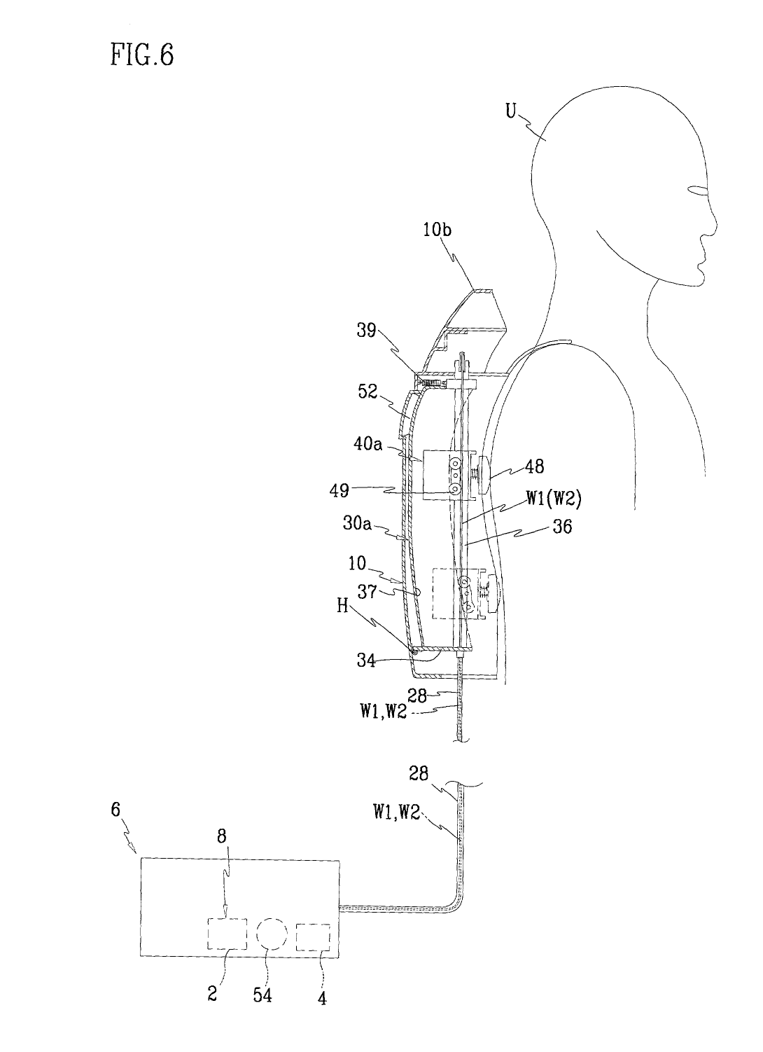

The massage means M receives power required for the massage operation from the motor 2 via the power transmission part 8 As shown in FIGS. 2, 4 and 6, the massage means M includes a pair of supporting members 32 vertically mounted on an inner wall of the main body 10a, a lower plate 34 coupled by a hinge member H on the inner wall of the main body 10a under the supporting members 32, a rear plate 37 fixed on the rear portion of the supporting members 32 to be disposed on the rear wall of the main body 10a, an air bag 52 disposed between the main body 10 and the rear plate 37, a guide member supported on the lower plate 34, and a roller 38 mounted on the guide member 36.

The wires W1 and W2 of the power transmission member 8 are released and wound by the roller 38.

The upper portion of the guide member 36 is disposed in the slot 13 formed on the top of the main body 10a such that it can move forward and rearward. The guide member 36 is biased rearward by an elastic member 39.

The supporting member 32 has a curvature radius identical to the curvature of the back of the human body. A back massage part 40a is provided such that it can move along the curvature of the supporting member 32 to perform the massage operation.

The back massage part 40a is fitted in the guide member 36 and comprises a slider 44 coupled to one of the wires W1 and W2, the slider ascending and descending as the wire coupled released and wound, plural press parts 48 disposed on both sides of the slider 44 and performing the massage operation according to a solenoid 46, a guide roller for allowing the solenoid 46 to move along the curvature as the slider 44 ascends and descends, and a vibrator 50 for vibrating the press parts 48 by vibrating the plate 44.

The elastic member 60 lets the guider roller contact the curvature 31 when the slider 44 moves along the curvature 31.

In addition, the air bag 52 disposed between the upper rear surface of the supporting members 32 and the main body 10a biases the massage part 40a to the back of the human body so that the massage part 40a closely contacts the massage part 40a regardless of the shape of the back.

The air bag 52 is connected to an air injector 54 mounted on the driving part 6 through a tube 55 so as to be supplied with air from the air injector 54. As the air injector 54, a small compressor may be used.

A thermo-heater (not shown) that can be electrically heated may be mounted on the slider so as to enhance the massage efficiency by providing a thermotherapy effect.

The operation of the massage means M will be described in detail hereinafter.

When the motor 2 rotates, the rotational motion is converted into a reciprocal motion by the power transmission part 8 so that the wires W1 and W2 pulls and pushes the massage part 40a, thereby ascending and descending the slider 44.

At this point, the solenoid 46 operates the press parts 48 according to the control of the control part 4 such that the press parts 48 knead the back. In addition, when the vibrator 50 vibrates at a predetermined cycle under the control of the control part 4, since the vibration is transmitted to the press parts 48, the press parts 48 provides the kneading and vibration effects to the back.

Alternatively, it is possible that according to the control of the control part, after the kneading effect is provided at a predetermined time, the vibration effect may be provided at a predetermined time. That is, the kneading effect and the vibration effect can be alternately provided under the control of the control part 4.

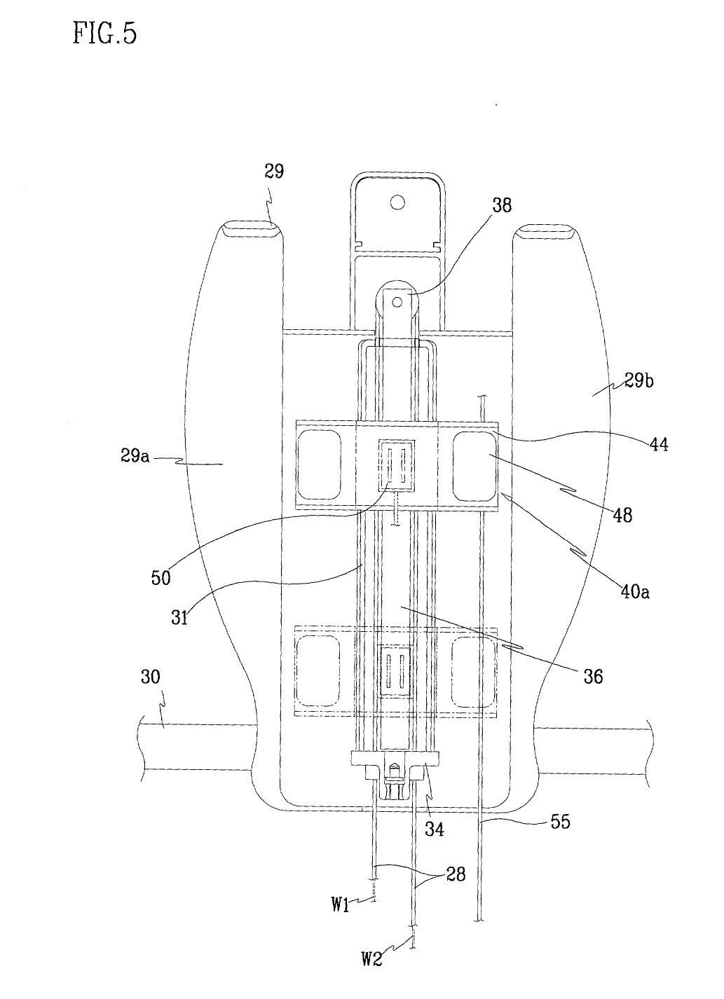

In use of the above-described massage device, it is first put on the back such that the supporting part 29 is hung on the shoulders of the user U, and then waist belt 30 and the shoulder belt (not shown) are properly fastened as shown in FIG. 5.

Next, the air injector 54 is operated to inject air into the air bag 52 such that the massage part 40a tightly contact the back of the user U.

After the massage device is completely put on the human body as described above, electric power is turned On to operate the motor 2, and a massage mode is selected by adjusting the massage mode switch (not shown) or the controller 4.

The driving gear G1 rotates together with the motor 2, and the rotational force is transmitted to the driving shaft 14 via the driven gear G2 engaged with the driving gear G1.

The roll 16 rotates clockwise or counterclockwise and the RPM of the roll is detected by the sensor, thereby reciprocating the wires W1 and W2 wound around the roller 16.

By this operation, the slider 44 fixed on one of the wires W1 and W2 ascends and descends, thereby ascending and descending the massage part 40a. At this point, by the operation of the solenoid 46, the press parts 48 knead the back, and by the operation of the vibrator 50, the slider vibrates to enhance the massage effect.

As described above, the kneading and vibration is controlled by the control part 4.

The ascending and descending of the slider 44 is realized along the curvature 31 of the supporting member 32, which is identical to that of the back. As a result, uniform massage force is applied to the entire portion of the back.

To stop the massage operation, the electric power is turned Off, and the waist belt 30 and the shoulder belt are released to remove the massage device from the body.

As described above, since the massage device is used in a state where it is put on the body, it is convenient to get the massotherapy, while saving a space.

While this invention has been described in connection with what is presently considered to be the most practical and preferred embodiments, it is to be understood that the invention is not limited to the disclosed embodiments, but, on the contrary, is intended to cover various modifications and equivalent arrangements included within the spirit and scope of the appended claims.

What is claimed is:

1. A massage device comprising:
a supporting cover designed to be put on a human body;
massage means for massaging the back while moving along a part of the human body, on which the supporting cover being put, the massage means being provided in the supporting cover; and
a driving part for driving and controlling the massage means.

2. A massage device of claim 1 further comprising a power transmission part disposed between the massage means and the driving part to convert a rotational motion of the driving part into a linear reciprocal motion.

3. A massage device of claim 2 wherein the power transmission part comprises a driving shaft supported by a pair of supporting blocks facing each other, a roll fixed on the driving shaft to rotate with the driving shaft, and wires connected to a proximal end of the roll and extended out of the driving part.

4. A massage device of claim 3 wherein a sensor is provided in the power transmission part to detect a roll RPM, a detected signal being transmitted to the motor.

5. A massage device of claim 1 wherein the supporting cover further comprises a supporting part designed having a similar curvature to that of a specific body part on which they are to be put on.

6. A massage device of claim 1 wherein the massage means comprises a pair of supporting members vertically mounted on an inner wall of the main body, a lower plate coupled by a hinge member on the inner wall of the main body under the supporting members, a rear plate fixed on the rear portion of the supporting members to be disposed on the rear wall of the main body, an air bag disposed between the main body and the rear plate, a guide member supported on the lower plate, a roller mounted on the guide member, and a back massage part for massage the back while ascending and descending along the guide member

7. A massage device of claim 6 wherein the back massage part comprises a slider in the guide member coupled to one of the wires, the slider ascending and descending as the wire coupled released and wound, plural press parts disposed on both sides of the slider and performing the massage operation according to a solenoid, a guide roller allowing the solenoid to move along the curvature as the slider ascends and descends.

8. A massage device of claim 7 wherein the back massage part further comprises a vibrator for vibration the press parts by vibrating the slider.

9. A massage device of claim 6 wherein the back massage part further comprises a thermo heater for generating heat by electric power.

10. A massage device of claim 6 further comprising an air back for biasing the back massage part to the human body, the air back being disposed between the main body and the supporting members.

11. A massage device of claim 1 wherein the massage means is controlled in its kneading and vibration operations by a control part.

12. A massage device of claim 1 wherein the massage means is controlled in its operation time and operation mode by a control part.

13. A massage device of claim 1 wherein the driving part comprises a mode switch for adjusting a massage time and a massage mode.
